(19) United States
(12) Patent Application Publication
(10) Pub. No.: US 2026/0182615 A1
(43) Pub. Date: Jul. 2, 2026

(54) COFFEE BEAN ROASTING SYSTEM

(71) Applicant: SOCIÉTÉ DES PRODUITS NESTLÉ S.A., Vevey (CH)

(72) Inventors: Grégory SAVIOZ, Saxonne (CH); Youcef AIT BOUZIAD, Echandens (CH)

(21) Appl. No.: 19/131,601

(22) PCT Filed: Nov. 1, 2023
(86) PCT No.: PCT/EP2023/080499

§ 371 Date: May 21, 2025

(30) Foreign Application Priority Data
Nov. 28, 2022 (GB) 2217817.2
Dec. 6, 2022 (EP) 22211695.6
Dec. 6, 2022 (EP) 22211696.4

(51) Int. Cl. A23N 12/12; A23F 5/04

(52) U.S. Cl. CPC A23N 12/125; A23F 5/046

(57) ABSTRACT

A coffee bean roasting machine comprising: a roasting unit with a roasting chamber to roast a dose of coffee beans; a dosing unit, and; a coffee bean reservoir to contain multiple doses of coffee beans, wherein the dosing unit is arranged to extract a pre-portioned dose of coffee beans from the multiple doses of coffee beans of the reservoir and to transfer the pre-portioned dose to the roasting unit.

### TECHNICAL FIELD

The present disclosure relates to electrically operated coffee bean roasting machines, with which roasted coffee beans are prepared from unroasted coffee beans.

### BACKGROUND

Systems for the roasting of coffee beans are implemented to chemically and physically alter properties of unroasted green coffee beans into roasted coffee beans. Roasted coffee beans produce a characteristic flavour in coffee.

Such systems typically implement large, stand alone machines, which are capable only of roasting large batches of coffee beans in the order of several Kg at a time. A drawback is that smaller establishments, including a coffee shop, operating such machines has said large batches waiting for significant periods of time before use, which may lead to a suboptimal roasting freshness of said beans being used.

Therefore, in spite of the effort already invested in the development of said systems further improvements are desirable.

### SUMMARY

The present disclosure provides a coffee bean roasting machine comprising: a roasting unit with a roasting chamber to roast a dose of coffee beans; a dosing system comprising a dosing unit and a coffee bean reservoir to contain multiple doses of coffee beans. The dosing unit is arranged to extract a pre-portioned dose of coffee beans from the multiple doses of coffee beans of the reservoir and to transfer the pre-portioned dose to the roasting unit.

The roasting unit includes: a roasting chamber inlet arranged to cooperate with a dosage outlet of the dosing unit (e.g. so the roasting chamber can receive the dose from the dosing system), and; a separate roasting chamber outlet for outlet of roasted coffee beans. By implementing a separate inlet and outlet for the coffee beans, the machine may execute subsequent roasting process without removal of the roasting unit (including part thereof) since the coffee beans are able to flow through the roasting chamber via the inlet and outlet.

The roasting chamber inlet is movable between an open position and a closed position, in the closed position the roasting chamber inlet blocks air from an air transmission system and/or coffee beans from transmission therethrough; in the open position the roasting chamber inlet enables transmission of coffee beans therethrough (e.g. from a dosage outlet of the dosing unit). By having an actuatable inlet, flow conditions of the beans and/or air may be controlled.

The roasting chamber outlet is movable between an open position and a closed position: in the closed position the chamber outlet blocks air from an air transmission system and/or coffee beans from transmission therethrough, and; in the open position the roasting chamber outlet enables transmission of coffee beans through the roasting chamber outlet and optionally said air from the air transmission system. By having an actuatable outlet, flow conditions of the beans and/or air may be controlled.

The roasting unit includes: an air inlet arranged to transfer air from an air transmission system to the roasting chamber, and; an air outlet, which may be separate from the inlet, for outlet of exhaust of air from the air transmission system and material from the roasting chamber. By implementing a separate inlet and outlet a flow path for the air in the roasting chamber may be implemented which may improve roasting.

The air outlet is movable between an open position and a closed position, in the closed position the air outlet inlet blocks air from the air transmission system from exiting the roasting chamber; in the open position the air outlet inlet enables air from the air transmission system from exiting the roasting chamber. By having an actuatable outlet, flow conditions of the air may be controlled.

The roasting unit is configurable with one or more of the following configurations:

A roasting configuration, in which the roasting chamber inlet and/or the roasting chamber outlet are arranged in a closed position, and the air outlet (or more generally the flow regulator) is arranged in an open position. In this way air may be transmitted through the flow path to roast the beans, without the air and/or beans escaping via the roasting chamber outlet and/or the roasting chamber inlet.

A dosing configuration, in which the roasting chamber inlet is arranged in an open position and the roasting chamber outlet is arranged in a closed position. In this way beans can enter the roasting chamber from the dosing system for roasting without escaping via the roasting chamber outlet. The air outlet (or more generally the flow regulator) may also be arranged in a closed position. In this way beans may be prevented from escaping via the air outlet (or flow regulator).

An extraction configuration, in which and the roasting chamber outlet is arranged in an open position. The air outlet (or more generally the flow regulator) may be arranged in an open, including a partially open, or closed position to control/force air flow through the roasting chamber outlet to aid with ejection of beans through the roasting chamber outlet. In this position the roasting chamber inlet may arranged in the closed position to prevent roasted beans or air exiting via the roasting chamber inlet.

By implementing a dosing system to derive a pre-set fixed portion size of unroasted coffee beans from a container that comprises multiple loose doses of unroasted coffee beans, a single dose can be processed at a time by the roasting unit, rather than the full multiple doses all in the container at once. Accordingly, small doses of roasted coffee beans can be supplied on demand rather than as multiple doses in bulk, which may lead to roasted coffee beans that are of optimal freshness being used when required for a grinding and coffee preparation process.

In embodiments, a capacity of the roasting chamber of the roasting unit is dimensioned to correspond to that of the pre-portioned dose transferred by the dosing system. For example, the roasting chamber is dimensioned so that the roasting chamber can contain the dose at 10-50% occupation of its volume so that there is free space to enable movement of the coffee beans in the roasting chamber during roasting to collide with each other.

In embodiments, the pre-portioned dose extracted by the dosing unit is 100-200 g of unroasted coffee beans. The pre-portioned dose is a fixed amount independent of an amount of coffee beans present in the reservoir (unless the reservoir is empty or comprises less than a single dose of coffee beans). In embodiments, an internal volume of the roasting chamber of the roasting unit is 0.25-0.75 litres. Such a volume may correspond to said dosage.

In embodiments, the dosing system comprises a positioning system to direct the coffee beans in the reservoir to a portioner unit to portion the pre-portioned dose of coffee beans from the positioned coffee beans. Such an arranged may be convenient for automation.

In embodiments, the portioner unit is arranged to transmit the received dose to a dosage outlet of the dosing system. In embodiments, the dosing system includes an actuator unit (e.g. which is controlled by the electrical circuitry) arranged to actuate the portioner unit.

In embodiments, the coffee bean reservoir and/or the dosing unit are removably attached to the coffee bean roasting machine. A removable reservoir may be more convenient to fill with unroasted coffee beans.

In embodiments, the coffee bean roasting machine is configured with the roasting unit (e.g. the roasting chamber thereof) not to require removal from the machine (e.g. the assembly of the other components of the machine and/or at least a body of the machine) as part of the roasting process. By arranging the roasting unit not to be removable as part of the roasting process (e.g. it may be automatically filled with a dose and automatically dispense to an outlet roasted coffee beans) the removal of the roasting unit (e.g. for refilling with beans) may be obviated, which is desirable since the roasting unit may become hot in use and therefore dangerous to handle.

In embodiments, the roasting chamber inlet is arranged above the roasting chamber outlet. By arranging the inlet to be located in a depth direction (e.g. in use) above the outlet, the dosing unit may feed beans into the roasting chamber gravitationally.

In embodiments, the air inlet and air outlet define a flow path for air of the air transmission system, which is arranged to extend through a pre-portioned dose of coffee beans in the roasting chamber. The air outlet may be arranged above the air inlet. By implementing the flow path to extend through the dose of coffee beans (e.g. with the inlet located at their base and the outlet arranged to carry the flow from their base to their top) improved roasting may be achieved.

The flow path may comprise a flow regulator, which is arranged to control the flow path through the roasting chamber, which has open (including open and semi-open) and closed positions. The flow regulator is typically implemented as the air outlet with said open and closed positions.

In embodiments, the air outlet and roasting chamber inlet are moved between the associated open and closed positions by actuation of a common member. By implementing a common member a single actuator system may be used to drive the common member to control said outlet and inlet.

In embodiments, the dosing system is arranged to transfer the pre-portioned dose to the roasting chamber with the roasting unit in the dosing configuration.

In embodiments, the coffee bean roasting machine comprises an air transmission system to deliver air (e.g. hot air at 150-250° C.) to the roasting chamber along a flow path. In embodiments, the air transmission system comprises: a flow generator; a heat exchanger to heat the air, and; a filtering unit to filter material from the air. In embodiments, the flow path includes the air inlet and the air outlet of the roasting chamber.

In embodiments, the coffee bean roasting machine comprises a delivery system arranged to transfer roasted coffee beans through the roasting chamber outlet of the roasting unit to an outlet container (e.g. with the roasting unit in the extraction configuration and air supplied by the air transmission system).

The present disclosure provides a method of roasting coffee beans. The method may implement the features of any preceding embodiment or another embodiment disclosed herein. In embodiments, the method comprises: extracting, with an automated dosage system, a pre-portioned dose of coffee beans from a reservoir configured to contain multiple doses of coffee beans; transferring with the automated dosage system the pre-portioned dose to a roasting unit; roasting the pre-portioned dose with the roasting unit, and; transferring the roasted pre-portioned dose from the roasting unit to an outlet.

The present disclosure provides a coffee roasting system comprising the roasting machine according to one ore more of the previous feature and further comprising: a processing unit with a roasting chamber to roast a pre-portioned dose of coffee beans; electrical circuitry to control the processing unit to execute a roasting process in which said pre-portioned dose of coffee beans is roasted, wherein the electrical circuitry is configured to control the processing unit to execute automatically a series (e.g. two or more after the other) of roasting processes so that pre-portioned doses are roasted sequentially.

By implement the coffee roasting system to implement more than one roasting process in a row automatically, without user instruction for each roasting process, the system can roast multiple doses either one after the other when there is a shortage determined or at predefined times when a shortage is to be expected.

As used herein the term “automatically” may refer to an automated control process, which is without user instruction via a user interface subsequent to an initial instruction, e.g. it is not necessary for user intervention from the ending of one roasting process to the initiation of another in the series.

In embodiments, the electrical circuitry comprises a user interface configured to provide (e.g. as a result of a user input) an instruction comprising one or more of a time to execute one or more roasting processes (e.g. the time may be set to periods of the day of high demand, including in the morning or at midday); a frequency of roasting processes to execute (e.g. this may be a predetermined number of roasting processes per hour over an entire day or over one or more user selected hours in the day, or a first time period for a first predetermined frequency and a second time period for a second predetermined frequency), and; an amount (e.g. a number of pre-portioned doses to roast, or an instruction to roast an entire amount of coffee beans present in the reservoir as sequential pre-portioned doses until the reservoir is depleted) of coffee to roast. In embodiments, the electrical circuitry is configured to control the processing unit (e.g. the roasting unit, a dosing system and an air transmission system) to execute roasting processes according the one or more instructions. It will be understood that said commands may also be for execution of a single roasting process (rather than several as a sequence).

In embodiments, the electrical circuitry is configured to receive the instruction from: a user interface of the coffee bean roasting machine (e.g. which includes the roasting unit), and/or; a user interface of a portable electronic device (e.g. a mobile phone), which is separate from said machine and in electronic communication therewith by means of a communication interface.

In embodiments, coffee roasting system comprises a dosing system which is controlled by the electrical circuitry. The dosing system is arranged to extract a pre-portioned dose of coffee beans from a reservoir (e.g. of multiple portions of loose coffee beans) and to transfer the pre-portioned dose to the roasting unit.

In embodiments, the electrical circuitry is configured to determine if sufficient coffee beans are present in the reservoir for extraction of a predetermined number of doses (e.g. one or more doses, which may be according to the instructions) and if present then to execute a roasting process (e.g. one or more roasting processes, which may be according to the instructions).

In embodiments, if insufficient coffee beans are present in the reservoir for extraction of said predetermined number of doses, the electrical circuitry may not execute a roasting process or may only execute a number of roasting processes that there are doses for in the reservoir (e.g. less than the instructed number of roasting processes). The electrical circuitry may alternatively or in addition provide a notification to a user interface (e.g. to notify a user that there are insufficient doses present in the reservoir to execute the instructions). Such an implementation may avoid unnecessary energy usage or damage to the machine since a roasting process is only executed when there is sufficient coffee beans present for a dose.

In embodiments, the electrical circuitry is configured to determine if the reservoir is present, and if present then to execute a roasting process. In embodiments, if the reservoir is not determined as present then a roasting process may not be executed. The electrical circuitry may alternatively or in addition provide a notification to a user interface (e.g. to notify a user that the reservoir is not present). Such an implementation may avoid unnecessary energy usage or damage to the machine since a roasting process is only executed when the reservoir is present (e.g. with coffee beans present).

In embodiments, the electrical circuitry is configured to provide a notification to a user interface of a completed roasting process. By notifying a user that a roasting process has completed, they may collect the immediately roasted coffee and/or provide instructions to execute another roasting process.

In embodiments, the system includes a delivery system comprising an outlet container for containment of roasted coffee beans from the roasting unit. The outlet container may contain multiple doses of the roasted coffee beans, such that it does not need replacing for each dose.

In embodiments, the electrical circuitry is configured to determine if the outlet container is present, and if present then to execute a roasting process including to dispense roasted coffee beans to the outlet container.

In embodiments, if the outlet container is not determined as present then a roasting process may not be executed. In embodiments, if the outlet container is not determined as present then roasting process maybe executed but not including a step of dispense roasted coffee beans to the outlet container (said step may subsequently be executed once an outlet container is detected). The electrical circuitry may alternatively or in addition provide a notification to a user interface (e.g. to notify a user that the outlet container is not present). Such an implementation may avoid unnecessary energy usage or damage to the machine since a roasting process is only executed when an outlet container is present to contain the roasted coffee beans.

In embodiments, the electrical circuitry is configured to determine a fill condition of the outlet container (e.g. no roasted coffee beans are present or less than or more than a predetermined amount, such as one or more doses, is present), and if the fill condition is met then to execute or not to execute a roasting process.

By determining a first fill condition if there is less than a particular amount of roasted coffee beans in the outlet container and then automatically executing a roasting process, the outlet container may be maintained with a partial amount of roasted coffee beans such that a condition of a shortage may not arise.

By determining a second fill condition if there is more than a particular amount of roasted coffee beans in the outlet container and then automatically preventing further execution of roasting process, the outlet container may be maintained with a partial amount of roasted coffee beans such that a condition of an overfill may not arise.

The present disclosure provides a method of roasting coffee beans. The method may implement the features of any preceding embodiment or another embodiment disclosed herein. In embodiments, the method comprises: automatically controlling (e.g. with electrical circuitry) a processing unit to execute automatically a series of roasting processes, in which said pre-portioned dose of coffee beans is roasted, so that pre-portioned doses are roasted sequentially.

The methods may be implemented as part of a method of preparing a beverage, in which a grinding unit grinds the roasted coffee beans and a ground coffee processing unit processes the grinded coffee beans to extract a beverage therefrom.

The present disclosure provides a computer readable medium comprising program code, which may be executable on one or more processors, to implement the method of the preceding embodiments or another embodiment disclosed herein.

The electrical circuitry or computer readable medium may comprise program code (e.g. including instructions) to cause the processing unit to execute said methods.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for roasting coffee beans.

FIG. 2 is a block system diagram showing an embodiment machine of the system of FIG. 1.

FIG. 3 is a block system diagram showing an embodiment processing unit of the machine of FIG. 2.

FIG. 3 is perspective view showing an embodiment of the machine of FIG. 2.

FIGS. 5-7 are respective side perspective, side and top sectional views showing an embodiment dosing system of the machine of FIG. 3.

FIGS. 8 and 9 are respective top perspective and side sectional views showing an embodiment roasting unit of the machine of FIG. 3.

FIGS. 10-12 are top and top perspective views showing the roasting unit of FIGS. 8 and 9 in respective dosing, roasting and extraction configurations.

FIG. 13 is an illustrative diagram showing an embodiment air transmission system of the machine of FIG. 2.

FIG. 14 is a block system diagram showing an embodiment electrical circuitry of the system of FIG. 1.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that can execute a roasting process on unroasted coffee beans to derive therefrom roasted coffee beans. The machine may implement said process by one or more of the following processes: heating; pressurisation; impacting between beans; agitation of beans to improve a uniformity of transmission of heat to the beans. The machine may be dimensioned for use on a work top, e.g. it may be less than 70 cm in length, width and height. The machine may be configured to operate from a mains AC electrical supply, e.g. 110-240 v at 40-70 hz. The machine may be movable by an individual user, e.g. it is less than 10 kg.

As used herein, the term “unroasted coffee beans” may refer to natural green coffee beans, which may have some processing, e.g. fermenting or drying or partial/pre-roasting. As used herein, the term “roasted coffee beans” may refer to coffee beans which have been subject to a roasting process, such that they are distinguishable from unroasted coffee beans in chemical and physical appearance, e.g. they are light, medium, medium-dark, and dark brown in colour with reduced moisture content.

As used herein, the term “roasting process” may refer to a process of subjecting unroasted coffee beans to temperatures (e.g. 150-250° C.) as part of an endothermic and/or exothermic process, and optional impacting with other beans to achieve roasted coffee beans.

As used herein, the term “pre-portioned” or “dose” may refer to a pre-set fixed mass (e.g. 100 g or 150 g or 200 g or any of the aforesaid ±20 or 40% or 100-200 g), volume or number of coffee beans in either the unroasted or roasted form. The dose may be user selectable as one of a predetermined number of different fixed amounts. It may not, for example, be an amount of coffee beans present in a reservoir (e.g. unless this corresponds exactly to the dose). It may be intended to refer to an amount that is independent of an amount of coffee beans in the reservoir (e.g. unless there is less than a dose present in the reservoir).

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “roasting system” may refer to the combination of the roasting machine and one or more of the following: the coffee beans; the server system, and; the peripheral device.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

### [General System Description]

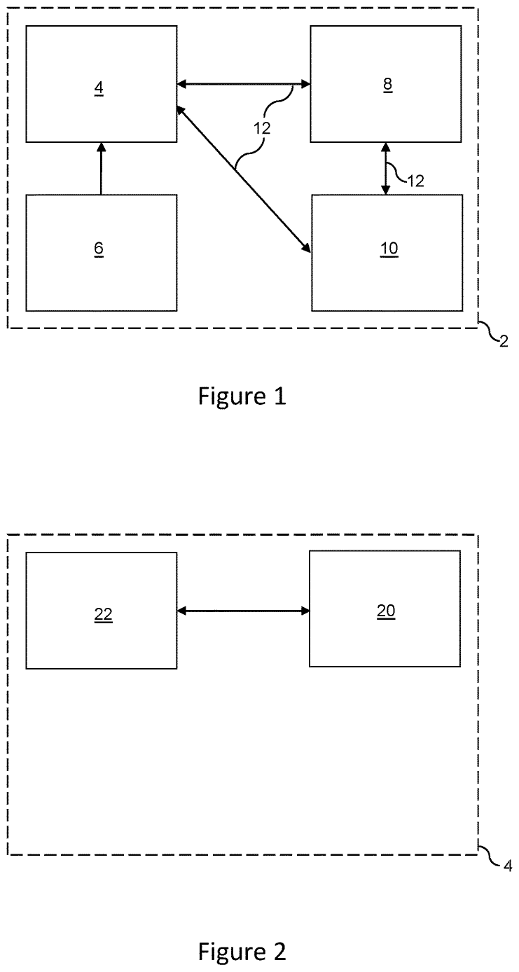

Referring to FIG. 1, the system 2 comprises a machine 4, coffee beans 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 20 for performing a roasting process in which loose, unroasted coffee beans 6 are processed to derive a pre-portioned dose of roasted coffee beans (not illustrated) therefrom, and; electrical circuitry 22 to control the processing unit 20 to execute said roasting process.

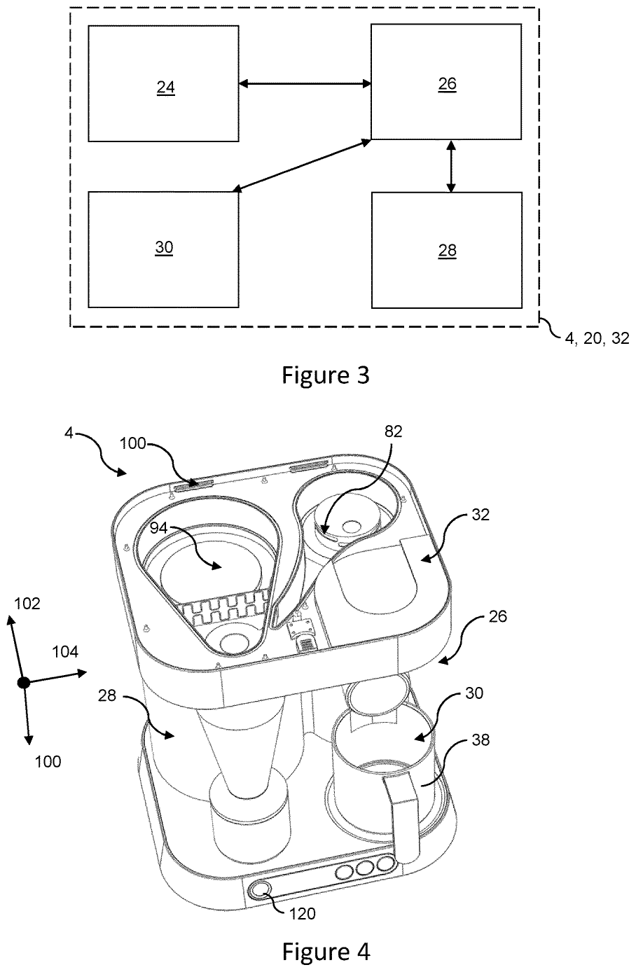

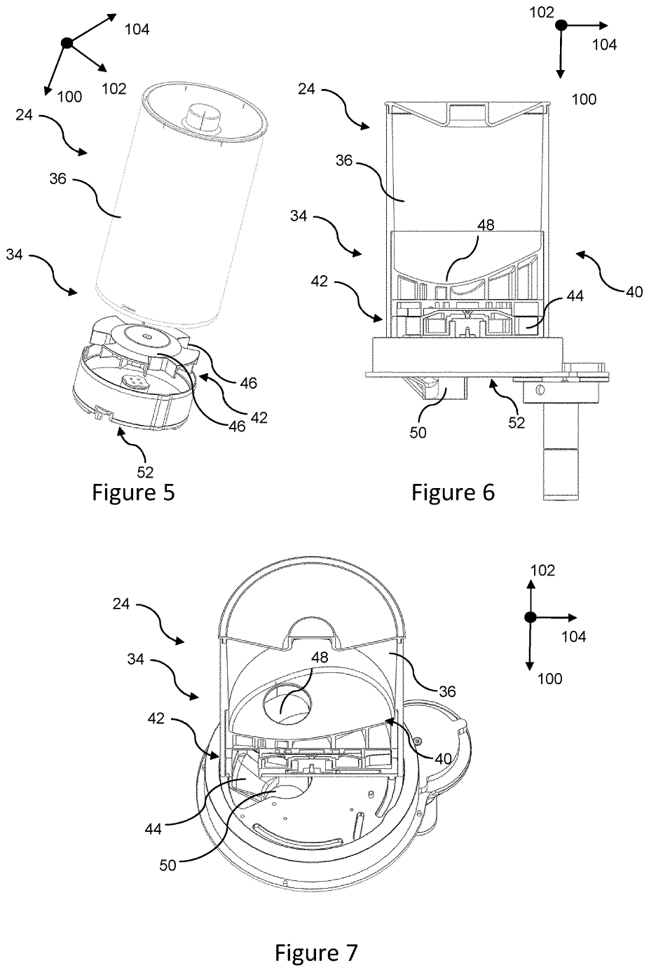

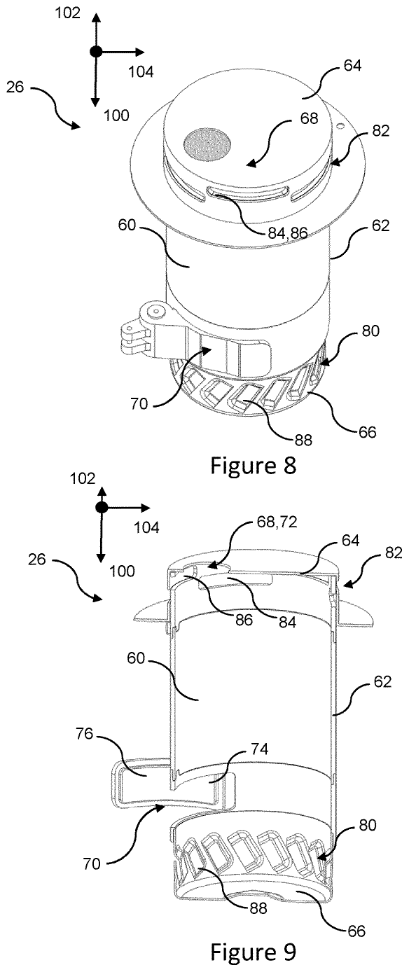

Referring to FIG. 3, the processing unit 20 of the machine 4 comprises: a dosing system 24 to extract a pre-portioned dose of unroasted coffee beans from a loose batch of multiple doses of unroasted coffee beans 6; a roasting unit 26 to receive and roast said pre-portioned dose of unroasted coffee beans; an air transmission system 28 to transmit heated air for roasting the coffee beans to the roasting unit 26, and; a delivery system 30 to deliver a pre-portioned dose of roasted coffee beans from the roasting unit 26.

The dosing system 24, roasting unit 26, air transmission system 28, and delivery system 30 are connected to or form part of a machine body.

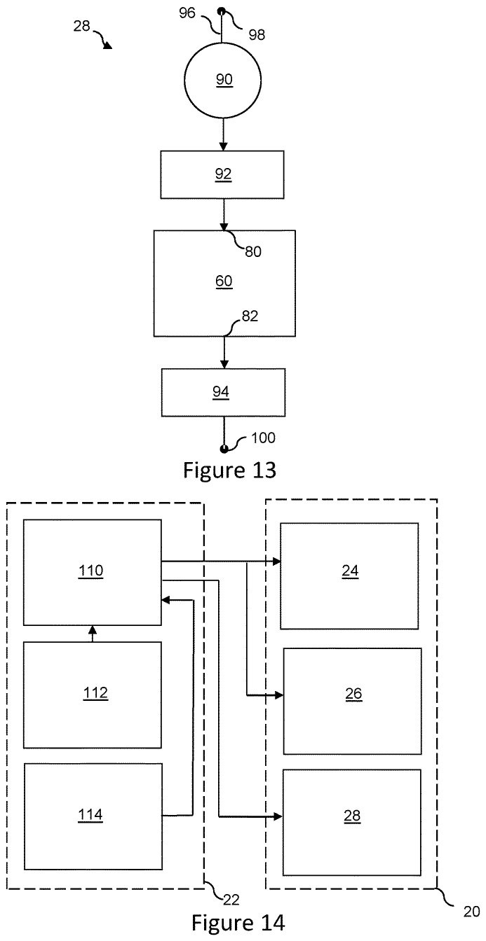

An example machine 4 assembly comprising the aforesaid components (less a top cover, which is not illustrated, and the dosing system 24) is shown in FIG. 4; a compatible dosing system 24 is shown in FIGS. 5-7; the roasting unit 26 is shown in more detail FIGS. 8 and 9, and the air transmission system 28 is shown in FIG. 13.

The machine 4 has a global depth direction 100, a longitudinal direction 102, and a lateral direction 104, which will be referred to when describing the machine 4 and its components. In use, the depth direction 100 is aligned to a vertical direction.

### [Dosing Systems]

Referring to FIGS. 5-7, a first example of the dosing system 24 comprises a reservoir 36 and a dosing unit 34. The dosing unit 34 is arranged to extract a pre-portioned dose of coffee beans (not illustrated) from the multiple, loosed doses of coffee beans in the reservoir 36 and to transfer said pre-portioned dose to the roasting unit 26.

The dosing unit 34 comprises a positioning system 40 to direct the coffee beans in the reservoir 36 to a portioner unit 42, which derives the pre-portioned dose of coffee beans from the positioned coffee beans.

In the example, the positioning system 40 comprises a funnel arrangement within the reservoir 36. Hence the positioning system 40 is separable from the machine body 32 with the reservoir 36. The funnel is arranged to narrow in the lateral direction 104 and longitudinal direction 102 with respect to the depth direction 100, towards a base of the reservoir 36. The base of the reservoir 36 comprises a reservoir outlet 48, which is also positioned proximal the portioner unit 42 to direct the positioned coffee beans thereto.

In variant embodiments, which are not illustrated, the positioning system is formed separated from the reservoir, e.g. the reservoir has an outlet that couples coffee beans to the positioning system, and the positioning system as formed with the portioner unit or is removable coupled thereto etc; the positioning system may also be omitted, e.g. the reservoir is formed as an elongate column that feeds directly on to the portioning system.

The portioner unit 42 is arranged as a rotary member 44 with cut-out sections 46. An actuator unit (not illustrated) drives the rotary member 44 to rotate about an axis that extends in the depth direction 100. The outlet 48 of the of the positioning unit 42 periodically algins with a cut-out section 46 as they rotate at which point the coffee beans in the funnel of the reservoir 36 are enabled to transfer under gravity as a portioned amount into the cut-out sections 46. As the rotary member 44 is further rotated, the portioned coffee beans are dragged rotationally to a dosing system outlet 50. With the cut-out sections 46 aligned to the dosing system outlet 50 the coffee beans in the cut-out sections 46 are enabled to transfer under gravity as a portioned amount into roasting unit 26, as will be discussed. A base wall 52 of the dosing unit 34 prevents the coffee beans from exiting at positions other than the dosing system outlet 50. One or more cut-out sections 46 may be used to define a single pre-portioned dose, e.g. the pre-portioned dose may have different fixed amounts, to correspond to one or more cut-out sections 46, as may be programmed in the electrical circuitry 22, including selectable as a user input to a user interface as will be discussed.

In variant embodiments, which are not illustrated, alternative dosing systems are implemented, for example: in the example embodiment, the portioner unit as described is replaced by an auger or counter rotating rollers that rotate for a predetermined amount of time or otherwise to define the pre-portioned dose; such a system may also be implemented without a positioning unit, e.g. an auger extending directly into a reservoir; pre-portioned containers that individually contain the pre-portioned dose may also be contained by the dosing system, which extracts a dose therefrom, e.g. by opening and dispensing the dose from a container. Such systems may also have several fixed dose quantities that are user selectable.

The coffee bean reservoir 36 and/or the dosing unit 34 are removably attached to the body 32 of the machine 4 and/or each other. In variant embodiments, which are not illustrated, one or more of said components are integrally formed with each other.

### [Roasting Unit]

Referring to FIGS. 8 and 9 the roasting unit 26 includes a roasting chamber 60 for roasting the pre-portioned dose of coffee beans supplied by the dosing system 24. The roasting chamber 60 is cylindrical in shape, with a side wall 62 between a top wall 64 and a bottom wall 66. The cylindrical shape is arranged in use with the cylindrical axis in the depth direction 100 with the bottom wall 66 at a greater depth than the top wall 64.

In variant embodiments, which are not illustrated, the roasting chamber is alternatively shaped, e.g. it is cubical or frustoconical or a truncated pyramid.

The roasting chamber 60 is dimensioned to contain the pre-portioned dose at 10-50% or 15-30% occupation of its internal volume. The internal volume can be 0.1-0.9 or 0.25-0.75 or about 0.5 litres. The large proportion of unoccupied volume enables movement of the coffee beans in the roasting chamber 60 during roasting to collide with each other as the air is passed over them, which can cause a skin/outer layer of the coffee beans to be removed and transported as debris from the roasting chamber 60 by the air, as will be discussed.

The roasting unit 26 includes a roasting chamber inlet 68 arranged through the top wall 64 to cooperate with a dosage outlet 50 of the dosing system 24 so the roasting chamber 60 can receive the pre-portioned dose. The roasting unit 26 includes a roasting chamber outlet 70 arranged through the side wall 62 to outlet the roasted coffee beans, as will be discussed.

The roasting chamber inlet 68 is therefore arranged above, with respect to the depth direction 100, the roasting chamber outlet 70. In this manner the roasted product may flow through the roasting chamber 60 with the assistance of gravity, rather than require its extraction from the machine 4 body 32 as will be discussed.

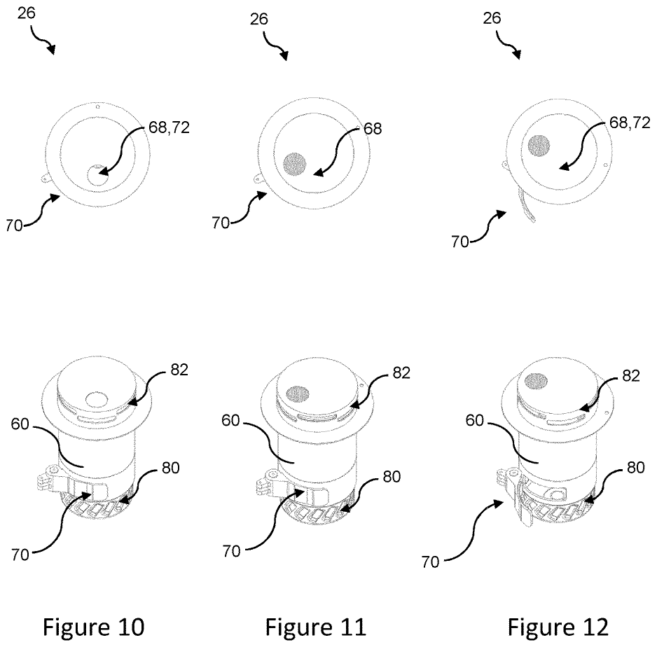

The roasting chamber inlet 68 is movable between an open position (FIG. 10) and a closed position (FIGS. 8, 11, 12). In the closed position the roasting chamber inlet 68 blocks air (including said debris that may be present in the air) from the air transmission system 28 and coffee beans from transmission through the roasting chamber inlet 68. In the open position the roasting chamber inlet 68 enables transmission of coffee beans therethrough.

The roasting chamber inlet 68 is formed as an inlet aperture 72 in the top wall 64, which rotates as an end cap about the side wall 62. In the open position the inlet aperture 72 aligns with the dosage outlet 50 of the dosing system 24. In the closed position the inlet aperture 72 is not aligned with the dosage outlet 50, such that the base wall 52 of the dosing system 24 closes the inlet aperture 72.

An actuator unit (not illustrated) drives the roasting chamber inlet 68 between the open and closed positions by rotation of the end cap.

In variant embodiments, which are not illustrated, the roasting chamber inlet is alternatively implemented, for example: rather than a rotating end cap, the top wall and side wall are integrally formed and a closing member is moved relative an inlet aperture in the to wall to achieve the open and closed positions; the roasting chamber inlet is formed in the side wall; the roasting chamber inlet is arranged as a hatch that pivots between the open and closed positions as for the roasting chamber outlet.

The roasting chamber outlet 70 is movable between an open position (FIG. 9) and a closed position (FIG. 8). In the closed position the roasting chamber outlet 70 blocks air (including said debris that may be present in the air) from an air transmission system 28 and coffee beans from transmission through the roasting chamber outlet 70. In the open position the roasting chamber outlet 70 enables transmission of coffee beans therethrough.

The roasting chamber outlet 70 is formed as an outlet aperture 74 in the side wall 62, and a hatch 76 which pivots about an axis aligned to the depth direction 100. In the open position the hatch 76 is separated from the outlet aperture 74. In the closed position the hatch 76 is closes the outlet aperture 74. The outlet aperture 74 is located proximal the bottom wall 66, but separated therefrom in the depth direction 100.

An actuator unit (not illustrated) drives the roasting chamber outlet 70 between the open and closed positions by rotation of the hatch 76.

In variant embodiments, which are not illustrated, the roasting chamber outlet is alternatively implemented, for example: rather than a rotating hatch, the same outlet as for the roasting chamber inlet or any of the discussed variants are implemented, including a ring with an aperture that aligns with the outlet aperture in a first rotary positions and closes the outlet aperture in a second rotary position.

The roasting unit 26 includes an air inlet 80 arranged to transfer air from an air transmission system 28 to the roasting chamber 60. The roasting unit 26 includes an air outlet 82 for outlet of exhaust of air from the air transmission system 28 and debris from the roasting chamber 60. The air inlet 80 and air outlet 82 implement part of a flow path 84 which, in the roasting chamber 60 extends though the pre-portioned dose of coffee beans, as will be discussed.

The air outlet 82 is arranged as a plurality of outlet apertures 84, which are distributed circumferentially through the side wall 62 proximal but separated from the top wall 64. The end cap forming the top wall 64 includes corresponding outlet apertures 86. The outlet apertures 84, 86 are aligned (or at least partially aligned in an open position or semi-open position as will be discussed) or are fully out of alignment in a closed position.

Accordingly, the air outlet 82 is movable between an open position (FIG. 8) and a closed position (FIG. 9). In the closed position the air outlet 82 blocks air from the air transmission system 28 from exiting the roasting chamber 60; in the open position the air outlet enables 82 air from the air transmission system 28 to exit the roasting chamber 60.

An actuator unit (not illustrated) drives the air outlet 82 between the open and closed positions by rotation of the end cap. Since the end cap actuates the roasting chamber inlet 68 and the air outlet 82, it is a common member that can be driven by the same actuator.

In variant embodiments, which are not illustrated: the air outlet may be alternatively arranged, including as for the examples and variants discussed for the roasting chamber inlet (e.g. it may be on the top wall); there may be no open and closed positions; the air outlet may be permanently in the open position; the air outlet can have a single outlet aperture; the air inlet and air outlet may be integrated, e.g. one flow path used for both different flow directions sequentially and a bleed/relief valve for pressure equalisation.

The air inlet 80 is arranged as a plurality of inlet apertures 88 distributed circumferentially through the side wall 62 proximal but separated from the bottom wall 66.

In variant embodiments, which are not illustrated, the air inlet is arranged as for the air outlet and its associated variants, e.g. it may include closed and open positions in addition to or instead of the flow outlet; both the air inlet and air outlet are in the side wall such that the flow path extends through the dose of coffee beans in the lateral/and/or longitudinal direction (as opposed to general in the depth direction in the illustrated example).

Both the air inlet and/or air outlet may be referred to more generally as a flow regulator for the processing chamber, with open and closed positions to control the flow therethrough. The associated components of the roasting unit may have any suitable operative arrangement. For example, the flow regulator, roasting chamber inlet and roasting chamber outlet do not require integral formation with the roasting chamber, they can be distributed anywhere on the machine, e.g. the roasting chamber inlet may be arranged on the dosing system, the flow regulator may be elsewhere in the flow path (as will be discussed).

### [Configurations of Roasting Chamber]

In embodiments, the roasting unit 26 is configurable with one or more of the following configurations:

A dosing configuration (FIG. 10), in which the roasting chamber inlet 68 is arranged in the open position and the roasting chamber outlet 70 is arranged in the closed position. In this way beans can enter the roasting chamber 60 from the dosing system 24 for roasting without escaping via the roasting chamber outlet 70. The air outlet 82 may be arranged in the closed position. In this way beans may be prevented from escaping via the air outlet.

A roasting configuration (FIG. 11), in which the roasting chamber inlet 68 and the roasting chamber outlet 70 are arranged in a closed position, and the air outlet 82 is arranged in the open position. In this way air may be transmitted through the flow path to roast the beans, without the air and/or beans escaping via the roasting chamber outlet 70 or the roasting chamber inlet 68.

An extraction configuration (FIG. 12), in which and the roasting chamber outlet 70 is arranged in the open position. The air outlet 82 is arranged in the partially open position to control/force air flow through the roasting chamber outlet 70 to aid with ejection of beans through the roasting chamber outlet 70. In this position the roasting chamber inlet 68 may be arranged in the closed position to prevent roasted beans exiting via the roasting chamber inlet 68.

The roasting unit 26 is controlled by the electrical circuitry 22 (as will be discussed) between said positions. The electrical circuitry 22 also controls the dosing unit 24 to transfer the pre-portioned dose to the roasting chamber 60 with the roasting unit 26 in the dosing configuration.

The coffee bean roasting machine 4 is configured with the roasting unit 26 not to require removal from said machine 4 (e.g. the assembly of the other components of the machine and/or the body 32 of the machine) as part of the roasting process.

That is, without removal of the roasting chamber 60, the electrical circuitry 22 is configured to control the processing unit 20 to automatically execute a roasting process, which comprises deriving a pre-portioned dose, roasting the pre-portioned dose and dispensing the pre-portioned dose. In the illustrated example, this comprises the electrical circuitry 22 controlling the dosing system 24 to dose the roasting unit 26 with the pre-portioned dose and controlling the roasting unit 26 to move between the dosing configuration, roasting configuration and extraction configuration in an automated manner with corresponding control of the air transmission system 28 as will be discussed.

It will therefore be understood that the machine 4 is configured without removal of the roasting chamber 60 required as part of the roasting process. Although the machine 4 is not limited to a roasting chamber 60 that can not be removed for cleaning or replacement purposes etc.

### [Air Transmission System]

Referring to FIG. 13, the air transmission system 28 comprises a flow generator 90 to generate an air flow; a heat exchanger 92 to heat the air, and; a filtering unit 94 to filter material (e.g. the debris from the coffee beans) and/or gases from the air (e.g. gasses that are a by-product of the roasting process, which may that have a particular in odour) after it has passed through the roasting chamber 60.

The flow generator 90 is implemented as a fan or other suitable system to generate a flow in the flow path. The heat exchanger 92 heats the air flow from the flow generator 90, and comprises a heating element arrange in the flow path or other suitable system. The filtering unit filters said material from the air by means of a cyclone type filtering system or other suitable system, e.g. an in-line filter that the air is permeable to but not said material/gasses.

Referring to FIGS. 4 and 13, a flow path 96 comprises: a flow path inlet 98; the flow generator 90; the heat exchanger 92; the air inlet 80 of the roasting unit 26?; the pre-portioned dose of coffee in the roasting chamber 60, the air outlet 82 of the roasting unit 60; the filtering unit 94, and a flow path outlet 100. The flow path 96 and flow generator 90 are configured to provide sufficient flow rate to agitate/move the coffee beans into each other in the roasting chamber 60.

In variant embodiments, which are not illustrated, the air transmission system is alternatively arranged, for example, the flow generator is arranged downstream of the roasting chamber and operates by suction. Other suitable arrangements of the components of the air transmission system are also to be understood as included in the disclosure. In other examples, the roasting chamber roasts the coffee beans by other means, including a hot plate without an air transmission system.

### [Delivery System]

Referring to FIGS. 4 and 8, the delivery system 30 is arranged to transfer roasted coffee beans through the chamber outlet 70 of the roasting unit to an outlet container 38. With the roasting unit 26 in the previously discussed extraction configuration (FIG. 12), the flow path 96 of the air transmission system 28 is modified to be diverted from the air outlet 82 to the roasting chamber outlet 70 such that it carries roasted coffee beans from the roasting chamber 60 through the roasting chamber outlet 70 and to the outlet container 38. For the modified flow path, the air does not require heating by the heat exchanger 92. A conduit (not illustrated) may interconnect the roasting chamber outlet 70 and the outlet container 38.

In variant embodiments, which are not illustrated, other delivery systems may be implemented, for example; a hatch at the base of the roasting chamber that is arranged over the outlet container, and; other systems which may not require air for extraction from the air transmission system.

### [Control Electrical Circuitry]

Referring to FIG. 14, the electrical circuitry 22 at least partially implements (e.g. in combination with hardware) an: input unit/user interface 110 to receive an input from a user confirming that the machine 4 is to execute a roasting process and other inputs (as will be discussed); a processor 112 to receive the input from the input unit 110 and to provide a control output to the processing unit 20, and; a feedback system 114 to provide feedback to the processing unit 20 during the roasting process, which may be used to control the roasting process.

As discussed previously, the electrical circuitry 22 can be distributed over the system 2 (e.g. on one or more of the machine 4, server system 8 and the peripheral deice 10). Accordingly, one or more of the: input unit 110; processor 112, and; a feedback system 114 can also be distributed in this way.

The input unit 110 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a consumable has been supplied to the machine by a user.

The feedback system 114 can implement one or more of the following or other feedback control based operations:

One or more flow sensor or fan speed sensor to determine a flow rate/volume of the air through the flow path 96, which may be used to ensure the flow rate of air to the roasting chamber 60 is at a target flow rate and thus regulate the power to the flow generator 90.

One or more temperature sensor(s) to determine a temperature of one or more of: the roasting chamber 60; the air of the flow path 96; the heat exchanger 92, which may be used to ensure the temperature of air to the roasting chamber 60 is at a target temperature, and thus regulate the power to the heat exchanger 92 and/or the flow generator 90.

One or more position sensor to determine a position (e.g. open, semi-open or closed) of one or more of the: the air outlet 82; the roasting chamber inlet 68; the roasting chamber outlet 70.

One or more level sensor to determine a level or presence of coffee beans in one or more of: the reservoir 36; the outlet container 38; the roasting chamber 60.

### [Method of Roasting Coffee Beans]

A method of roasting coffee beans comprises the following steps:
Step 1: extracting, with the dosing system 24, a pre-portioned dose of coffee beans from the reservoir 36. The electrical circuitry 22 controls the dosing system 24 to extract the pre-portioned dose of coffee beans as discussed above.
Step 2: transferring from the dosing system 24 the pre-portioned dose to the roasting unit 26. The electrical circuitry 22 controls the roasting unit 26 to be arranged in the dosing configuration as discussed above.
Step 3: roasting the pre-portioned dose with the roasting unit 26. The electrical circuitry 22 controls the roasting unit 26 to be arranged in the roasting configuration as discussed above, and the air supply system 28 to apply heated air to the flow path 96 as discussed above.
Step 4: transferring the roasted pre-portioned dose from the roasting unit 26 to the outlet container 38. The electrical circuitry 22 controls the roasting unit 26 to be arranged in the extracting configuration as discussed above, and the air supply system 28 to apply air to the modified flow path to assist with ejection as discussed above.

Prior to step 1, the reservoir 36 may be filled with multiple doses of loose unroasted coffee beans. This step may comprise emptying one or more containers, e.g. a pack, into said reservoir 36. The container(s) may comprise a code which is read by a code reader 120 (FIG. 4) of the electrical circuitry 22 that provides parameters to the processor 112 used in the roasting process. The parameters can be one or more of: a temperature of the roasting process (e.g. for the air or the roasting chamber or the heat exchanger); a time of the roasting process (e.g. over which the heated air is applied or a time in the roasting chamber); a flow rate of the air (e.g. power applied to the flow generator 92), and; a phase of the process for which one or more of said parameters is applied, wherein a roasting process comprises multiple sequential phases. Alternatively, default parameters or user selected parameters, which are entered via the user interface 110, may be used.

### [Method of Roasting Subsequent Doses of Coffee Beans]

Since the machine 4, in a fully automated manner, under the control of the electrical circuitry 22 can execute a roasting process (which comprises deriving a pre-portioned dose from the loose coffee beans (or otherwise), roasting said pre-portioned dose and dispensing the roasted pre-portioned dose to an outlet), the method as previously discussed can be executed with the electrical circuitry 22 configured to control the processing unit 20 to execute automatically (e.g. without user intervention) a series of subsequent roasting processes so that subsequent pre-portioned doses are roasted sequentially.

Said fully automated roasting process opens up a wide range of control options for the machine 4, that may be instructed via the user interface 110 by the user:

### Example 1:—Input of Time to Automatically Execute a Roasting Process

The user interface 110 is configured to provide as instructions a time to execute one or more roasting processes. For example, a user may enter via the user interface 110, a time when there is expected to be high demand for coffee, including morning or at midday.

### Example 2:—Input of Frequency to Automatically Execute a Roasting Process

The user interface 110 is configured to provide as instructions a frequency of execution of roasting processes. For example, a user may enter via the user interface 110 a predetermined number including 1-10 or 1-5 per hour or other time period including 12 hours or a full day.

The first and second example may be combined to have a first frequency of roasting processes over a first predetermined time period and a second frequency over a different second predetermined time period etc.

### Example 3:—Input of an Amount of Coffee Beans to Roast

The user interface 110 is configured to provide as instructions an amount. For example, a user may enter via the user interface 110 an amount in grammes or a number of pre-portioned doses to roast. The instruction may be also be to roast an entire amount of coffee beans in the reservoir 36 as sequential roasting processes until the reservoir 36 is spent.

One or more checks/notifications may be provided as part of the (including said example 1-3) roasting process(s), examples of which include:

### Example 1—Determination if Sufficient Beans Present in Reservoir

The electrical circuitry 22 is configured to determine if sufficient coffee beans are present in the reservoir 36 for extraction of a predetermined number of doses by the dosing unit 34, which may be one or more doses. The amount of coffee beans in the reservoir 36 can be determined by a level sensor, including an optical sensor or other suitable sensor.

If insufficient coffee beans are present in the reservoir for extraction of said predetermined number of doses, the electrical circuitry may not execute a roasting process or may only execute a number of roasting processes that there are doses for in the reservoir.

The electrical circuitry 22 may alternatively or in addition provide a notification to the user interface 110 to notify a user that there are insufficient doses present in the reservoir to execute the instructions.

### Example 2—Presence of Reservoir

The electrical circuitry 22 is configured to determine if the reservoir 36 is present. The presence of the reservoir 36 can be determined by a proximity sensor, including an optical sensor, magnetic sensor or other suitable sensor.

If the reservoir 36 is determined as present then a roasting process may be executed. If the reservoir 36 is not determined as present then a roasting process may not be executed.

The electrical circuitry 22 may alternatively or in addition provide a notification to the user interface 110 that the reservoir 36 is not present.

### Example 3—Notification of Completed Roasting Process

The electrical circuitry 22 is configured to provide a notification to the user interface 110 of a completed roasting process, e.g. once the dispensing system 30 has completed dispensing the pre-portioned dose to the outlet container 38 or after roasting in the roasting chamber 60 has been completed or at another suitable step in the roasting process.

### Example 4—Presence of Outlet Container

The electrical circuitry 22 is configured to determine if the outlet container 38 is present. The presence of the outlet container 38 can be determined by a proximity sensor, including an optical sensor, magnetic sensor or other suitable sensor.

If the outlet container 38 is determined as present then a roasting process may be executed, including step 4 (transferring the roasted pre-portioned dose from the roasting unit 26 to the outlet container 38). If the outlet container 38 is not determined as present then a roasting process may not be executed. Alternatively, if the outlet container 38 is not determined as present then the roasting process may be executed, however step 4 may not be executed, such that the roasted pre-portioned dose remains in the roasting unit 26. Step 4 may then be executed once an outlet container 38 is determined as present.

The electrical circuitry 22 may alternatively or in addition provide a notification to the user interface 110 that the outlet container 38 is not present.

### Example 5—Fill Condition of Outlet Container

The electrical circuitry 22 is configured to determine a fill condition of the outlet container 38. The fill condition in the outlet container 38 can be determined by a level sensor, including an optical sensor or a weight sensor or other suitable sensor.

In a first variant, a first fill condition may be that there are no roasted coffee beans present or less than a predetermined amount (e.g. one or more doses) present in the outlet container 38.

If said first fill condition is met then the electrical circuitry 22 automatically executes a roasting process. In this way it may be ensured that there is always a minimum amount of coffee beans present in the outlet container 38 to avoid a shortage. If the first fill condition is not met then a roasting process may not be executed.

In a second variant, a second fill condition may be that there are greater than a predetermined amount of roasted coffee beans present in the outlet container 38.

If said fill condition is met then the electrical circuitry 22 may not execute a roasting process. In this way it is ensured the outlet container 38 may not be overfilled.

The fill conditions may be set by the user interface 110.

The above methods may be implemented as part of a method of preparing a beverage, in which a grinding unit grinds the roasted coffee beans and a processing unit processes the grinded coffee beans to extract a beverage therefrom.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

LIST OF REFERENCES

2 System
4 Machine
20 Processing unit
24 Dosing system
34 Dosing unit
40 Positioning unit
48 Reservoir outlet
42 Portioner unit
44 Rotary member
46 Cut-out section
52 Base wall
50 Dosage outlet
36 Reservoir
26 Roasting unit
60 Roasting chamber
62 Side wall
64 Top wall
66 Bottom wall
68 Roasting chamber inlet
72 Inlet aperture
70 Roasting chamber outlet
74 Outlet aperture
76 Hatch
80 Air inlet
88 Inlet apertures
82 Air outlet
84, 86 Outlet apertures
28 Air transmission system
90 Flow generator
92 Heat exchanger
94 Filtering unit
96 Flow path
98 Flow path inlet
100 Flow path inlet
30 Delivery system
38 Outlet container
22 Electrical circuitry
110 Input unit
112 Processing unit
114 Feedback system
32 Body
6 Coffee Beans
8 Server system
10 Peripheral device

1: A coffee bean roasting machine comprising:
a roasting unit with a roasting chamber to roast a dose of coffee beans; and
a dosing system comprising a dosing unit and a coffee bean reservoir to contain multiple doses of coffee beans,
wherein the dosing unit is arranged to extract a pre-portioned dose of coffee beans from the multiple doses of coffee beans of the reservoir and to transfer the pre-portioned dose to the roasting unit,
wherein the roasting unit includes a roasting chamber inlet arranged to cooperate with a dosage outlet of the dosing unit, and the roasting unit further comprises a separate roasting chamber outlet for outlet of roasted coffee beans,
wherein the roasting chamber inlet is movable between an open position and a closed position, wherein the roasting chamber inlet in the closed position blocks air from an air transmission system and/or coffee beans from transmission therethrough, and the roasting chamber inlet in the open position enables transmission of coffee beans through the roasting chamber inlet to the roasting chamber from the dosage outlet of the dosing system,
wherein the roasting chamber outlet is movable between an open position and a closed position, wherein the roasting chamber outlet in the closed position blocks air from the air transmission system and/or coffee beans from transmission therethrough, and the roasting chamber outlet in the open position enables transmission of coffee beans through the roasting chamber outlet,
wherein the roasting unit includes an air inlet arranged to transfer air from the air transmission system to the roasting chamber, and the roasting unit further comprises a separate air outlet for outlet of exhaust of air from the air transmission system and material from the roasting chamber,
wherein the air outlet is movable between an open position and a closed position, wherein the air outlet in the closed position blocks air from the air transmission system from exiting the roasting chamber, and the air outlet in the open position enables air from the air transmission system from exiting the roasting chamber,
wherein the roasting unit is configurable with one or more of the following configurations:
a roasting configuration, in which the roasting chamber inlet and the roasting chamber outlet are arranged in the closed position, and the air outlet is arranged in the open position;
a dosing configuration, in which the roasting chamber inlet is arranged in the open position and the roasting chamber outlet is arranged in the closed position, and the air outlet is arranged in the closed position;
an extraction configuration, in which the roasting chamber outlet is arranged in the open position, and the air inlet is arranged in an open position.

2: The coffee bean roasting machine according to claim 1, wherein an internal volume of the roasting chamber of the roasting unit is 0.25-0.75 litres, and the pre-portioned dose extracted by the dosing unit is 100-200 g of unroasted coffee beans.

3: The coffee bean roasting machine according to claim 1, wherein the dosing system comprises a positioning system to direct the coffee beans in the reservoir to a portioner unit to portion the pre-portioned dose of coffee beans from the coffee beans.

4: The coffee bean roasting machine according to claim 3, wherein the portioner unit is arranged to transmit the pre-portioned dose to the dosage outlet of the dosing system.

5: The coffee bean roasting machine according to claim 3, wherein the dosing system includes an actuator unit arranged to actuate the portioner unit.

6: The coffee bean roasting machine according to claim 1, wherein the coffee bean reservoir and/or the dosing unit are removably attached to the coffee bean roasting machine.

7: The coffee bean roasting machine according to claim 1, wherein the coffee bean roasting machine is configured with the roasting unit not to require removal from the machine as part of a roasting process.

8: The coffee bean roasting machine according to claim 1, wherein the roasting chamber inlet is arranged above the roasting chamber outlet.

9: The coffee bean roasting machine according to claim 1, wherein the air inlet and the air outlet define a flow path for air of the air transmission system, and the flow path is arranged to extend through the pre-portioned dose of coffee beans in the roasting chamber, with the air outlet arranged above the air inlet.

10: The coffee bean roasting machine according to claim 1, wherein the air outlet and the roasting chamber inlet are moved between the open and closed positions by actuation of a common member.

11: The coffee bean roasting machine according to claim 10, wherein the dosing system is arranged to transfer the pre-portioned dose to the roasting chamber with the roasting unit in the dosing configuration.

12: The coffee bean roasting machine according to claim 1 comprising the air transmission system to deliver air for a roasting process along a flow path, the air transmission system comprising:
a flow generator;
a heat exchanger to heat the air; and
a filtering unit to filter material from the air,
the flow path including the air inlet and the air outlet of the roasting chamber.

13: The coffee bean roasting machine according to claim 1 comprising a delivery system arranged to transfer roasted coffee beans through the roasting chamber outlet to an outlet container.

14: A method of roasting coffee beans with a coffee bean roasting machine according to claim 1, the method comprising:
extracting, with an automated dosing system, a pre-portioned dose of coffee beans from a reservoir configured to contain multiple doses of coffee beans;
transferring with the automated dosing system the pre-portioned dose to a roasting unit;
roasting the pre-portioned dose with the roasting unit; and
transferring the roasted pre-portioned dose from the roasting unit to an outlet.

15: A coffee roasting system comprising the roasting machine according to claim 1 and further comprising:
a processing unit with a roasting chamber to roast a pre-portioned dose of coffee beans;
electrical circuitry to control the processing unit to execute a roasting process in which the pre-portioned dose of coffee beans is roasted,
wherein the electrical circuitry is configured to control the processing unit to execute automatically a series of roasting processes so that pre-portioned doses are roasted sequentially.

16: A method of roasting coffee beans with a coffee roasting system according to claim 15, the method comprising:
automatically controlling a processing system to execute automatically a series of roasting processes, in which said pre-portioned dose of coffee beans is roasted, so that pre-portioned doses are roasted sequentially.

17. (canceled)
